(19) United States
(12) Patent Application Publication
(10) Pub. No.: US 2026/0186319 A1
(43) Pub. Date: Jul. 2, 2026

(54) DISPLAY DEVICE

(71) Applicant: Industrial Technology Research Institute, Hsinchu (TW)

(72) Inventors: Wei-Chung Chen, Kaohsiung City (TW); Yi-Hsiang Huang, Changhua County (TW); Chun-Ting Lin, New Taipei City (TW); Chen-Wei Lin, Hsinchu City (TW); Ruo-Lan Chang, New Taipei City (TW)

(73) Assignee: Industrial Technology Research Institute, Hsinchu (TW)

(21) Appl. No.: 19/173,820

(22) Filed: Apr. 9, 2025

(30) Foreign Application Priority Data
Dec. 26, 2024 (TW) 113150893

(51) Int. Cl. G02B 30/33

(52) U.S. Cl. CPC G02B 30/33

(57) ABSTRACT

A display device includes a substrate, display elements, light-mixing wells, a light exit structure, and a filling layer. The display elements are disposed on the substrate and include first-color display elements and second-color display elements. The light-mixing wells are disposed on the display elements. Each light-mixing well overlaps at least one corresponding first-color display element and at least one corresponding second-color display element. Each light-mixing well has a first surface facing the substrate and a second surface facing the light exit structure, and an orthographic projection area of the first surface on the substrate is greater than an orthographic projection area of the second surface on the substrate. The light exit structure is disposed on the light-mixing wells. The filling layer is located between the light-mixing wells, wherein a refractive index of the filling layer is less than a refractive index of the light-mixing wells.

### CROSS-REFERENCE TO RELATED APPLICATION

This application claims the priority benefit of Taiwan application serial no. 113150893, filed on Dec. 26, 2024. The entirety of the above-mentioned patent application is hereby incorporated by reference herein.

### TECHNICAL FIELD

The disclosure relates to a display device.

### BACKGROUND

In a conventional stereoscopic display device that uses a light exit structure as a spatial modulator of light, the light exit structure is disposed on a flat panel display to reconstruct a stereoscopic image. Since the pixel structure design of the conventional flat panel display may easily lead to uneven color mixing, when different colors of light are imaged in space via the light exit structure, issues of color separation and/or imaging chromatic aberration may easily occur. In addition, a non-collimated light beam transmitted toward the light exit structure is likely to pass through an ineffective area of the light exit structure and form stray light, thereby causing poor stereoscopic imaging quality (for example, image dislocation, crosstalk, image blur, etc.).

### SUMMARY

A display device according to an embodiment of the disclosure includes a substrate, multiple display elements, multiple light-mixing wells, a light exit structure, and a filling layer. The display elements are disposed on the substrate and include multiple first-color display elements and multiple second-color display elements. The light-mixing wells are disposed on the display elements. Each of the light-mixing wells overlaps at least one corresponding first-color display element and at least one corresponding second-color display element. Each of the light-mixing wells has a first surface facing the substrate and a second surface facing the light exit structure, and an orthographic projection area of the first surface on the substrate is greater than an orthographic projection area of the second surface on the substrate. The light exit structure is disposed on the light-mixing wells. The filling layer is disposed between the light exit structure and the substrate and is located between the light-mixing wells. A refractive index of the filling layer is less than a refractive index of the light-mixing wells.

Several exemplary embodiments accompanied with drawings are described below to further describe the disclosure in detail.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a partial top schematic view of a display device according to an embodiment of the disclosure.

FIG. 2 is a cross-sectional schematic view corresponding to a section line I-I′ in FIG. 1.

FIG. 3 to FIG. 5 are respectively three three-dimensional schematic views of a light-mixing well of FIG. 1.

FIG. 6 is a partial top schematic view of a display device according to another embodiment of the disclosure.

FIG. 7 to FIG. 12 are respectively six other sectional schematic views corresponding to a section line I-I′ in FIG. 1.

### DETAILED DESCRIPTION OF DISCLOSURED EMBODIMENTS

Directional terms such as “upper”, “lower”, “front”, “rear”, “left”, and “right” mentioned in the disclosure are only directions with reference to the drawings. Therefore, the used directional terms are used to illustrate, but not to limit, the disclosure.

In the drawings, each drawing illustrates the general characteristics of a method, a structure, and/or a material used in a specific embodiment. However, the drawings should not be construed to define or limit the scope or the nature covered by the embodiments. For example, the relative sizes, thicknesses, and positions of various film layers, regions, and/or structures may be reduced or enlarged for clarity.

In the embodiments, the same or similar elements adopt the same or similar numerals, and redundant description thereof is omitted. In addition, features in different exemplary embodiments may be combined with each other without conflict, and simple equivalent changes and modifications made in accordance with the specification or the claims are still within the scope of the disclosure.

Terms such as “first” and “second” mentioned in the specification or the claims are only used to name different elements or distinguish different embodiments or scopes and are not used to limit the upper limit or the lower limit on the number of elements, nor used to define the manufacturing sequence or the disposition sequence of elements. Furthermore, the disposition of an element/a film layer on (or above) another element/film layer may include the case of presence or absence of an additional element/film layer between the two elements/film layers. In other words, the element/film layer may be directly or indirectly disposed on (or above) the other element/film layer. On the other hand, the direct disposition of an element/a film layer on (or above) another element/film layer means that the two elements/film layers are in contact with each other, and there is no additional element/film layer present between the two elements/film layers.

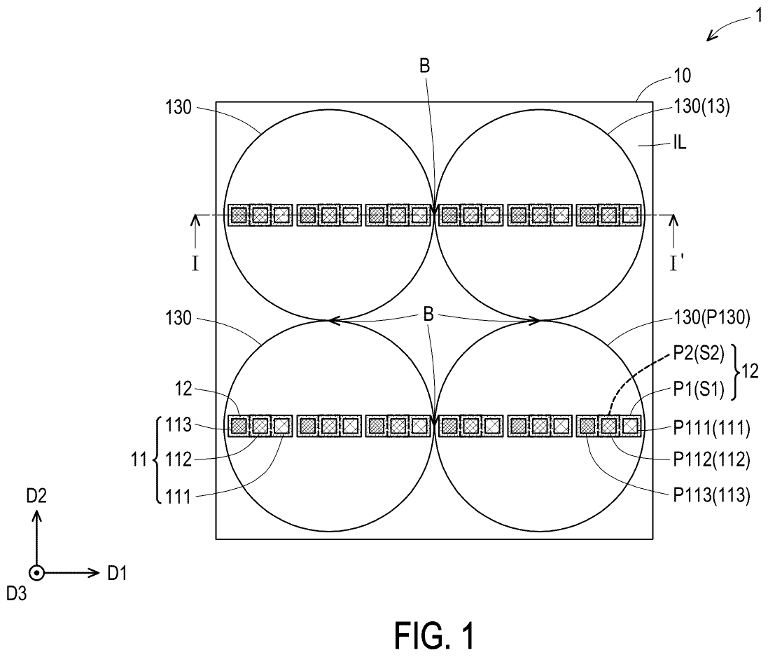

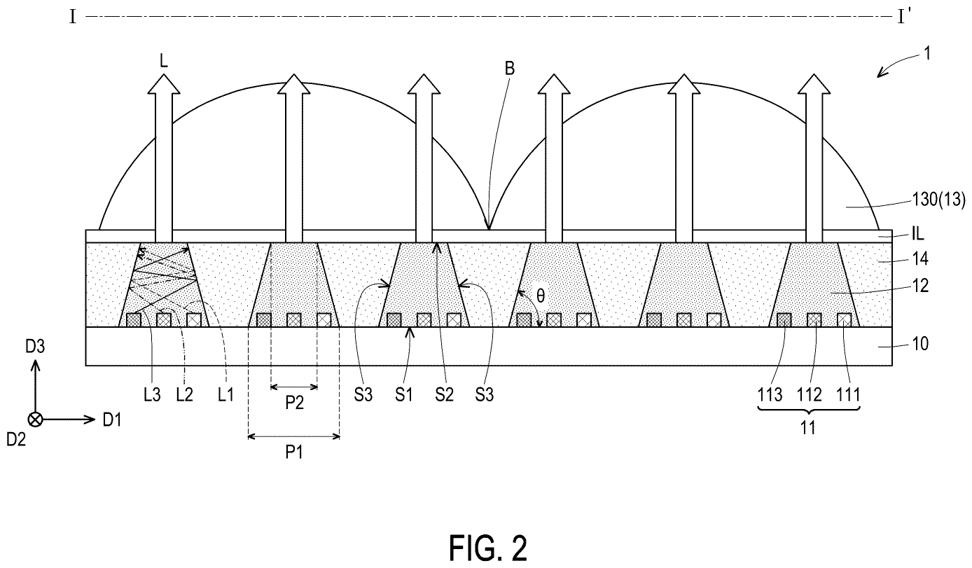

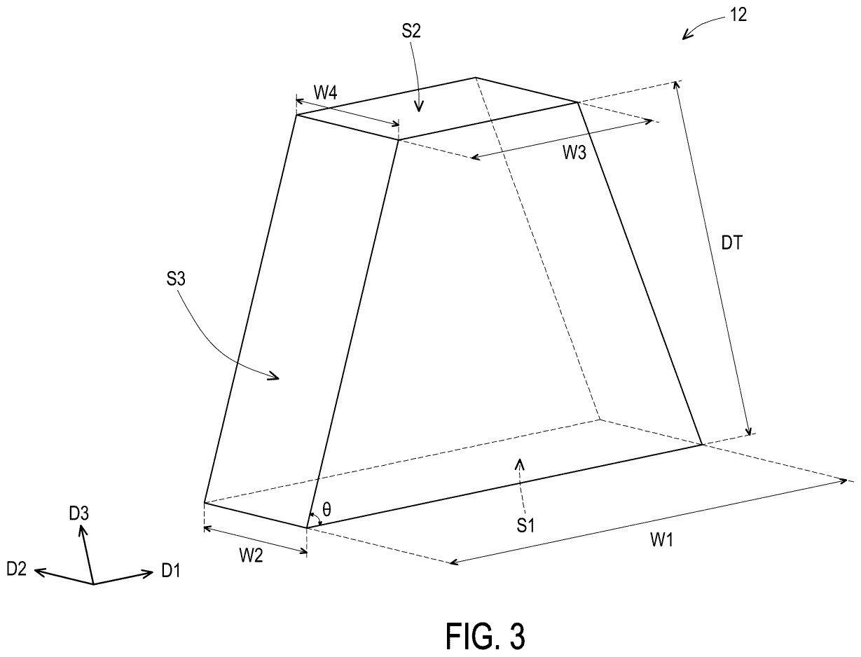

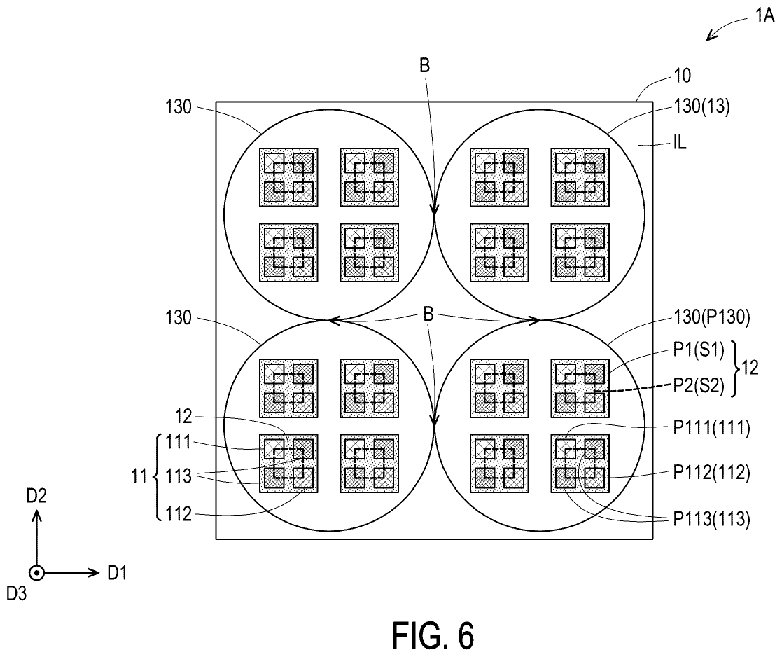

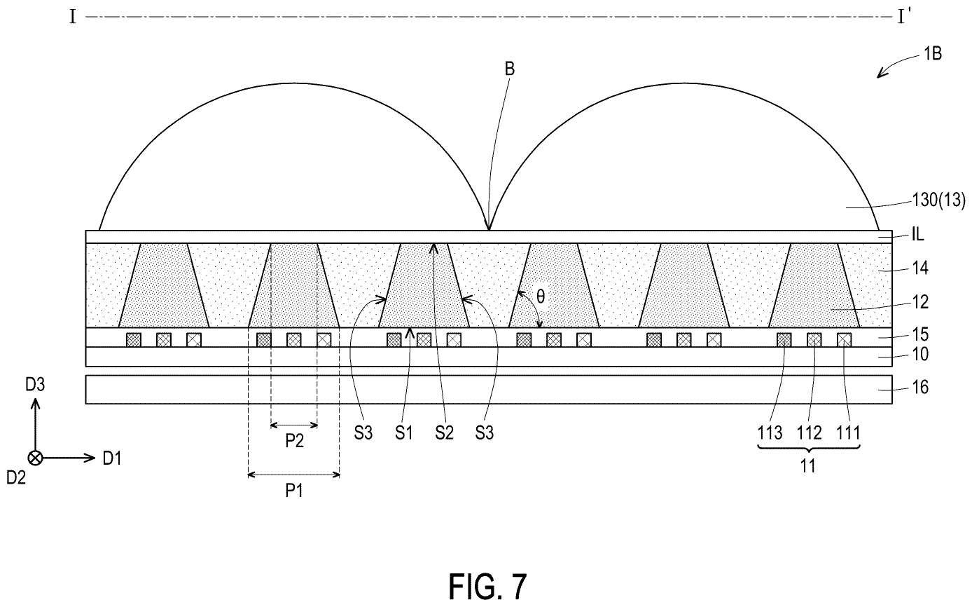

FIG. 1 is a partial top schematic view of a display device according to an embodiment of the disclosure. FIG. 2 is a cross-sectional schematic view corresponding to a section line I-I′ in FIG. 1. FIG. 3 to FIG. 5 are respectively three three-dimensional schematic views of a light-mixing well of FIG. 1. FIG. 6 is a partial top schematic view of a display device according to another embodiment of the disclosure. FIG. 7 to FIG. 12 are respectively six other sectional schematic views corresponding to a section line I-I′ in FIG. 1.

Please refer to FIG. 1 and FIG. 2 first. A display device 1 may include a substrate 10, multiple display elements 11, multiple light-mixing wells 12, a light exit structure 13, and a filling layer 14, but not limited thereto. According to different requirements, the display device 1 may further include one or more elements or film layers.

The substrate 10 is configured to carry the display elements 11, the light-mixing wells 12, the light exit structure 13, and the filling layer 14. In some embodiments, although not shown, the substrate 10 may include a base, multiple active elements (for example, a switching element, a sensing element, etc.), multiple passive elements (for example, a capacitor, a resistor, an inductor, etc.), multiple wires, and/or other conductive features (for example, conductive vias, pads, etc.), wherein the active elements, the passive elements, the wires, and/or other conductive features may be formed on the base through a panel process or a semiconductor process, and the active elements and the passive elements may be electrically connected to each other through the wires and/or other conductive features.

The display elements 11 are disposed on the substrate 10. The display elements 11 may be electrically connected to the active elements and/or the passive elements of the substrate 10 through the wires and/or other conductive features of the substrate 10, but not limited thereto. In some embodiments, the display elements 11 may be multiple micro light-emitting diodes, such as multiple vertical type micro light-emitting diodes, and the display elements 11 may be disposed on the substrate 10 and electrically connected to the substrate 10 through, for example, flip-chip bonding technology, but the type of the display element 11 and the manner of disposing the display element 11 on the substrate 10 may be changed according to requirements, but not limited thereto.

The display elements 11 may include multiple first-color display elements 111 and multiple second-color display elements 112, but not limited thereto. According to different designs, the display elements 11 may include multiple display elements of other colors. Taking FIG. 1 or FIG. 2 as an example, the display elements 11 may further include multiple third-color display elements 113, wherein the first-color display elements 111, the second-color display elements 112, and the third-color display elements 113 are, for example, alternately arranged along a first direction D1, and multiple display elements of the same color are, for example, arranged along a second direction D2. The second direction D2 intersects the first direction D1, and the first direction D1 and the second direction D2 are both perpendicular to the thickness direction (for example, a third direction D3) of the display device 1. In some embodiments, as shown in FIG. 1, the first direction D1 and the second direction D2 are, for example, perpendicular to each other, but not limited thereto.

In some embodiments, the first-color display elements 111, the second-color display elements 112, and the third-color display elements 113 are, for example, respectively multiple blue display elements, multiple green display elements, and multiple red display elements. In other words, a first light L1, a second light L2, and a third light L3 from the first-color display elements 111, the second-color display elements 112, and the third-color display elements 113 may respectively be blue light, green light, and red light, and a mixed light L of the first light L1, the second light L2, and the third light L3 is, for example, white light. However, it should be understood that the color types and the number of colors included in the display elements 11 and/or the arrangement manner of the display elements 11 may be changed according to actual requirements, but not limited thereto.

The light-mixing wells 12 are disposed on the display elements 11. For example, taking FIG. 2 as an example, each of the light-mixing wells 12 may laterally surround and cover the one or more corresponding display elements 11, but not limited thereto. The material of the light-mixing wells 12 may include an organic insulating material, an inorganic insulating material, or a combination thereof. The organic insulating material includes, for example, an organic photoresist material, such as a polyester material, polymethylmethacrylate (PMMA), an epoxy resin coating, or a high-refractive polymer. The inorganic insulating material includes, for example, a silicon nitride (SixNy), titanium dioxide, aluminum oxide, or sulfur polymer material, etc. The light-mixing wells 12 are, for example, formed through a photomask process, but not limited thereto.

As shown in FIG. 1 or FIG. 2, each of the light-mixing wells 12 may overlap the at least one corresponding first-color display element 111 and the at least one corresponding second-color display element 112. In an embodiment in which the display elements 11 further include the third-color display elements 113, as shown in FIG. 1 or FIG. 2, each of the light-mixing wells 12 may further overlap the at least one corresponding third-color display element 113. FIG. 1 and FIG. 2 schematically illustrate that each of the light-mixing wells 12 overlaps one corresponding first-color display element 111, one corresponding second-color display element 112, and one corresponding third-color display element 113, but it should be understood that the color types and the number of colors of the display elements and the number of display elements of each color overlapping each of the light-mixing wells 12 may be changed according to requirements, but not limited thereto.

In some embodiments, as shown in FIG. 1, under the architecture in which the light-mixing well 12 overlaps one corresponding first-color display element 111, one corresponding second-color display element 112, and one corresponding third-color display element 113, an orthographic projection P111 of the corresponding first-color display element 111 on the substrate 10, an orthographic projection P112 of the corresponding second-color display element 112 on the substrate 10, and an orthographic projection P113 of the corresponding third-color display element 113 on the substrate 10 may fall within an orthographic projection (for example, an orthographic projection P1) of the overlapping light-mixing well 12 on the substrate 10. The orthographic projection P111, the orthographic projection P112, and the orthographic projection P113, for example, fall completely within the orthographic projection P1 and do not fall outside the orthographic projection P1.

Each of the light-mixing wells 12 may have a first surface S1 facing the substrate 10 and a second surface S2 facing the light exit structure 13, and an orthographic projection area (with reference to the orthographic projection P1) of the first surface S1 on the substrate 10 is greater than an orthographic projection area (with reference to an orthographic projection P2) of the second surface S2 on the substrate 10. As shown in FIG. 2, the second surface S2 is a light exit surface of the mixed light L, that is, the mixed light L exits via the second surface S2 of the light-mixing well 12, and the first surface S1 is a surface opposite to the second surface S2. FIG. 1 schematically illustrates that the top-view shapes (for example, the shapes of the orthographic projection P1 and the orthographic projection P2) of the first surface S1 and the second surface S2 are both quadrilateral, but the top-view shapes of the first surface S1 and the second surface S2 may be changed according to requirements, but not limited thereto.

In some embodiments, as shown in FIG. 2, each of the light-mixing wells 12 may further have a side wall surface S3 located between the first surface S1 and the second surface S2 and inclined relative to the first surface S1, and an included angle θ between the side wall surface S3 and the first surfaces S1 is, for example, greater than or equal to 30 degrees and less than or equal to 80 degrees. In some embodiments, the side wall surface S3 connects the first surface S1 and the second surface S2, so that the cross-sectional shape of the light-mixing well 12 is trapezoidal, but the cross-sectional shape of the light-mixing well 12 may be changed according to requirements, but not limited thereto.

The light exit structure 13 is disposed on the light-mixing wells 12. For example, the light exit structure 13 may be attached to the light-mixing wells 12, but not limited thereto. In some embodiments, as shown in FIG. 1 or FIG. 2, the light exit structure 13 may include multiple micro lenses 130, but not limited thereto. In other embodiments, the light exit structure 13 may include a grating, a cylindrical lens, a meta-surface structure, etc. As shown in FIG. 1 or FIG. 2, the display device 1 may further include an interface layer IL, and the interface layer IL is located between the micro lenses 130 and the light-mixing wells 12.

In some embodiments, although not shown, the interface layer IL may include an attachment layer for adhering the micro lenses 130 to the light-mixing wells 12. In some embodiments, although not shown, the interface layer IL may include a base for carrying the micro lenses 130, and the base and the micro lenses 130 may be integrally formed. In some embodiments, although not shown, the interface layer IL may include the base and the attachment layer, wherein the base is located between the micro lenses 130 and the attachment layer.

The micro lenses 130 are disposed on the interface layer IL, and the micro lenses 130 may be arranged in an array along the first direction D1 and the second direction D2. The micro lenses 130 and the light-mixing wells 12 may be disposed in a one-to-one or one-to-many relationship. FIG. 1 and FIG. 2 schematically illustrate that the micro lenses 130 and the light-mixing wells 12 are disposed in a one-to-three relationship, that is, each of the micro lenses 130 is disposed corresponding to three light-mixing wells 12, but the number of the light-mixing wells 12 corresponding to each of the micro lenses 130 may be changed according to requirements, but not limited thereto.

In some embodiments, as shown in FIG. 2, the cross-sectional shape of each of the micro lenses 130 may be, for example, hemispherical. A hemisphere refers to a non-complete sphere, but is not limited to half of a sphere. In addition to being a plano-convex lens, the micro lens 130 may also be a biconvex lens, a concave-convex lens, etc. Furthermore, the curved surface of the micro lens 130 may be spherical or aspherical. In some embodiments, as shown in FIG. 1, the orthographic projection (for example, the orthographic projection P1) of each of the light-mixing wells 12 on the substrate 10 completely falls within an orthographic projection P130 of the overlapping micro lens 130 on the substrate 10, so that each of the light-mixing wells 12 does not overlap a boundary B of any two adjacent micro lenses 130 among the micro lenses 130. In other embodiments, although not shown, viewing from the top view, the light-mixing well 12 adjacent to the edges of the micro lenses 130 may slightly overlap the boundary B of the two adjacent micro lenses 130, wherein the second surface S2 of the light-mixing well 12 may not overlap the boundary B of any two adjacent micro lenses 130 among the micro lenses 130. In another embodiment, each of the display elements 11 may not overlap the boundary B of any two adjacent micro lenses 130 among the micro lenses 130.

The filling layer 14 is disposed between the light exit structure 13 and the substrate 10 and is located between the light-mixing wells 12. Taking FIG. 2 as an example, the filling layer 14 may laterally surround the light-mixing wells 12, but not limited thereto. In some embodiments, as shown in FIG. 2, the filling layer 14 may be flush with the second surface S2 of the light-mixing well 12. In some embodiments, as shown in FIG. 2, the filling layer 14 may expose the second surface S2 of the light-mixing well 12.

A refractive index of the filling layer 14 is less than a refractive index of the light-mixing wells 12. In some embodiments, the filling layer 14 may include an organic insulating layer, an inorganic insulating layer, or air, such as polytetrafluoroethylene (PTFE), a fluoride material, etc., but not limited thereto. In an embodiment in which the filling layer 14 includes the organic insulating layer, the filling layer 14 may be formed between the light-mixing wells 12 through coating.

The design of the refractive index of the filling layer 14 being less than the refractive index of the light-mixing wells 12 helps light to perform total internal reflection (TIR) in the light-mixing wells 12, so that the first light L1, the second light L2, and the third light L3 from the first-color display elements 111, the second-color display elements 112, and the third-color display elements 113 may be mixed via total internal reflection in the light-mixing wells 12, which helps in the formation of the white light (the mixed light L). In addition, through the design of the orthographic projection P1 being greater than the orthographic projection P2, the collimation of light may be improved (or the generation of stray light may be reduced) and/or light mixing may be improved. Therefore, issues such as color separation, imaging chromatic aberration, and/or poor imaging quality may be reduced, and color accuracy and/or image clarity in stereoscopic imaging may be effectively improved. In some embodiments, the collimation of light and/or light mixing may be further improved through the design of the included angle θ being greater than or equal to 30 degrees and less than or equal to 80 degrees.

Although FIG. 2 illustrates that the cross-sectional shape of the light-mixing well 12 is trapezoidal, the cross-sectional shape of the light-mixing well 12 is not limited thereto. In other embodiments, although not shown, the cross-sectional shape of the light-mixing well 12 may be, for example, pyramidal, cylindrical, hemispherical, other polygons, or a combination thereof.

FIG. 3 illustrates a three-dimensional schematic view of the light-mixing well 12. In an example, each display element may have a width of, for example, 5 μm in the first direction D1 and the second direction D2 and a pitch of, for example, 6.6 μm in the first direction D1. In the example, the first surface S1 may, for example, have a width W1 of 3 times the pitch (that is, 19.8 μm) in the first direction D1, the first surface S1 may, for example, have a width W2 of 1 time the pitch (that is, 6.6 μm) in the second direction D2, the second surface S2 may have a width W3 of, for example, 8.8 μm in the first direction D1, and the second surface S2 may, for example, have a width W4 of 1 time the pitch (that is, 6.6 μm) in the second direction D2, the included angle θ may be, for example, 70 degrees, and a distance DT between the first surface S1 and the second surface S2 in the third direction D3 may be, for example, 15 μm. As another option, the second surface S2 may have the width W3 of, for example, 14.5 μm in the first direction D1, the included angle θ may be, for example, 80 degrees, and the other parameters remain unchanged. As another option, the second surface S2 may have the width W3 of, for example, 5.9 μm in the first direction D1, the included angle θ may be, for example, 30 degrees, the distance DT between the first surface S1 and the second surface S2 in the third direction D3 may be, for example, 4 μm, and the other parameters remain unchanged. According to simulation results, it can be found that the included angle θ has a light mixing effect in a range of 30 degrees to 80 degrees. The size of the light-mixing well 12 and the included angle may be designed according to requirements, but the embodiments of the disclosure are not limited thereto.

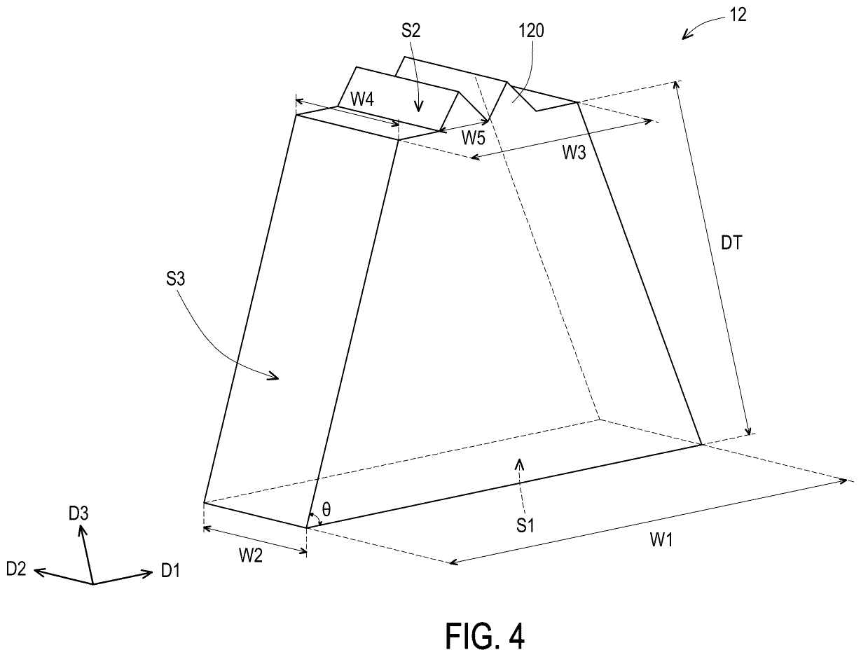

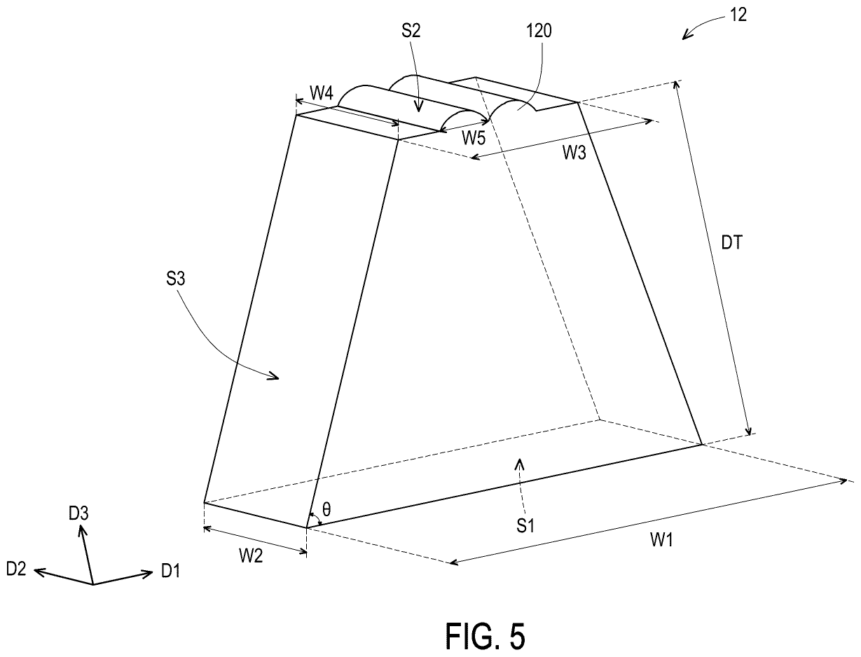

In some embodiments, light mixing may be further improved through forming at least one microstructure on the second surface S2 of the light-mixing well 12. As shown in FIG. 4 or FIG. 5, the second surface S2 of the light-mixing well 12 may include at least one microstructure 120, and the at least one microstructure 120 may, for example, include a triangular prism (with reference to FIG. 4) or a partial cylinder (with reference to FIG. 5), but not limited thereto. In an example, each display element may have a width of, for example, 5 μm in the first direction D1 and the second direction D2 and a pitch of, for example, 6.6 μm in the first direction D1. In the example, the first surface S1 may, for example, have the width W1 of 3 times the pitch (that is, 19.8 μm) in the first direction D1, the first surface S1 may, for example, have the width W2 of 1 time the pitch (that is, 6.6 μm) in the second direction D2, the second surface S2 may have the width W3 of, for example, 8.8 μm in the first direction D1, the second surface S2 may, for example, have the width W4 of 1 time the pitch (that is, 6.6 μm) in the second direction D2, the included angle θ may be, for example, 70 degrees, and the distance DT between the first surface S1 and the second surface S2 in the third direction D3 may be, for example, 15 μm. In an embodiment in which the microstructures 120 are multiple triangular prisms (with reference to FIG. 4), each of the microstructures 120 may have a width W5 of 3 μm in the first direction D1 and a vertex angle of 80 degrees, but not limited thereto. In an embodiment in which the microstructures 120 are multiple partial cylinders (with reference to FIG. 5), each of the microstructures 120 may have the width W5 of 3.5 μm in the first direction D1 and a radius of curvature of 2 μm, but not limited thereto. It should be understood that the examples are only for illustration and are not intended to limit the disclosure. The design parameters of the light-mixing well 12 may be changed according to design requirements (for example, the configuration and the size of the display element, the required light shape, product specifications, etc.). Furthermore, the second surface S2 of the light-mixing well 12 in any embodiment of the disclosure may form the at least one microstructure 120, and the design parameters of the microstructure 120 may also be adjusted according to requirements, which helps to further improve light mixing and will not be reiterated.

Please refer to FIG. 6. FIG. 6 illustrates other implementations of the arrangement manner of the display elements 11 and the relative disposition relationship of the display elements 11, the light-mixing wells 12, and the micro lenses 130. In a display device 1A, the first-color display elements 111 and the third-color display elements 113 are alternately arranged along the first direction D1 and the second direction D2, and the second-color display elements 112 and the third-color display elements 113 are alternately arranged along the first direction D1 and the second direction D2. In addition, each of the light-mixing wells 12 overlaps, for example, one corresponding first-color display element 111, one corresponding second-color display element 112, and two corresponding third-color display elements 113, wherein the first-color display element 111 and the second-color display element 112 are disposed along a diagonal line, and the two third-color display elements 113 are disposed along the other diagonal line. FIG. 6 schematically illustrates that the top-view shapes (for example, the shapes of the orthographic projection P1 and the orthographic projection P2) of the first surface S1 and the second surface S2 are both square, but the top-view shapes of the first surface S1 and the second surface S2 may be changed according to requirements, but not limited thereto.

FIG. 7 to FIG. 12 are changes made under the architecture of FIG. 2. It should be understood that changes or features in the embodiments may be selectively combined without conflict to form other embodiments not shown.

Please refer to FIG. 7. In a display device 1B, the display elements 11 include, for example, multiple display units (for example, multiple sub-pixels) in a liquid crystal display panel. For example, each of the display units may include a liquid crystal layer, a pixel electrode, a common electrode, and/or a color filter pattern, etc. Correspondingly, the substrate 10 may be an active element array substrate, and the display elements 11 may be formed on the substrate 10 through a known panel process. In addition, the display device 1B may further include an interposer 15 disposed between the display elements 11 and the light-mixing wells 12. The interposer 15 may be a single layer or a composite layer. For example, the interposer 15 may include a protective layer disposed on multiple color filter patterns, but not limited thereto. In addition, the display device 1B may further include a backlight module 16 to provide illumination light. The backlight module 16 may be a direct-type backlight module or an edge-type backlight module, but not limited thereto.

Alternatively, the display elements 11 may, for example, include multiple organic light-emitting diodes (OLEDs). Correspondingly, the substrate 10 may be an active element array substrate, and the display elements 11 may be formed on the substrate 10 through a known OLED process. Under such an architecture, the display device 1B may not include the backlight module 16.

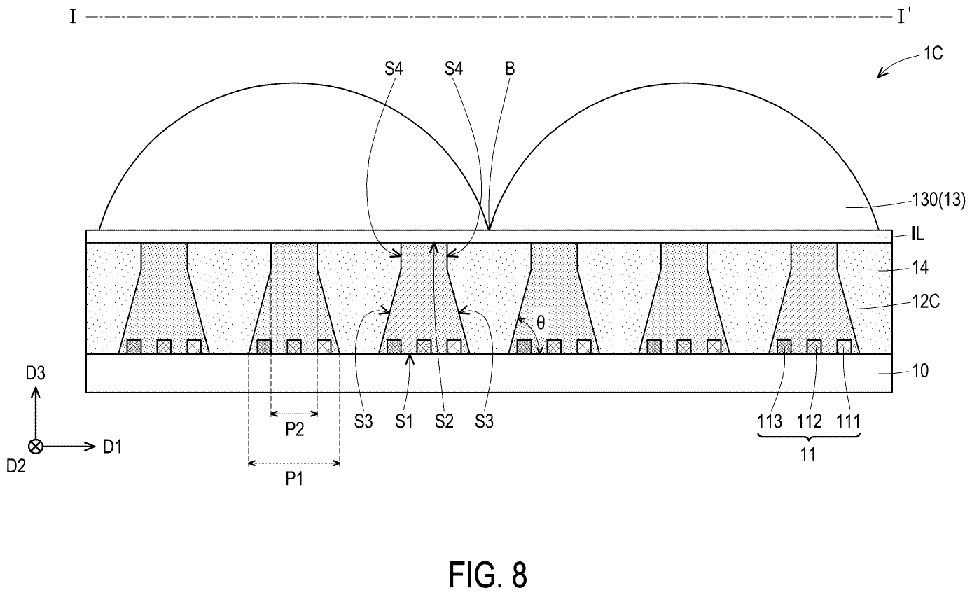

Please refer to FIG. 8. In a display device 1C, the side wall surface S3 is connected to the first surface S1, and each of multiple light-mixing wells 12C further has a side wall surface S4 connecting the side wall surface S3 and the second surface S2 to improve light mixing. In FIG. 8, the side wall surface S4 is, for example, perpendicular to the first surface S1 and the second surface S2, but an included angle between the side wall surface S4 and the first surface S1 or an included angle between the side wall surface S4 and the second surface S2 may be changed according to actual requirements, but not limited thereto.

In an example, each display element may have a width of, for example, 5 μm in the first direction D1 and the second direction D2 and a pitch of, for example, 6.6 μm in the first direction D1. In the example, the first surface S1 may, for example, have a width of 3 times the pitch (that is, 19.8 μm) in the first direction D1, the first surface S1 may, for example, have a width of 1 time the pitch (that is, 6.6 μm) in the second direction D2, the second surface S2 may have a width of, for example, 8.8 μm in the first direction D1, the second surface S2 may, for example, have a width of 1 time the pitch (that is, 6.6 μm) in the second direction D2, the included angle θ may be, for example, 70 degrees, the side wall surface S4 may have a width of, for example, 5 μm in the third direction D3, and a boundary of the side wall surface S4 and the side wall surface S3 may maintain a distance of, for example, 15 μm from the first surface S1 in the third direction D3, but not limited thereto.

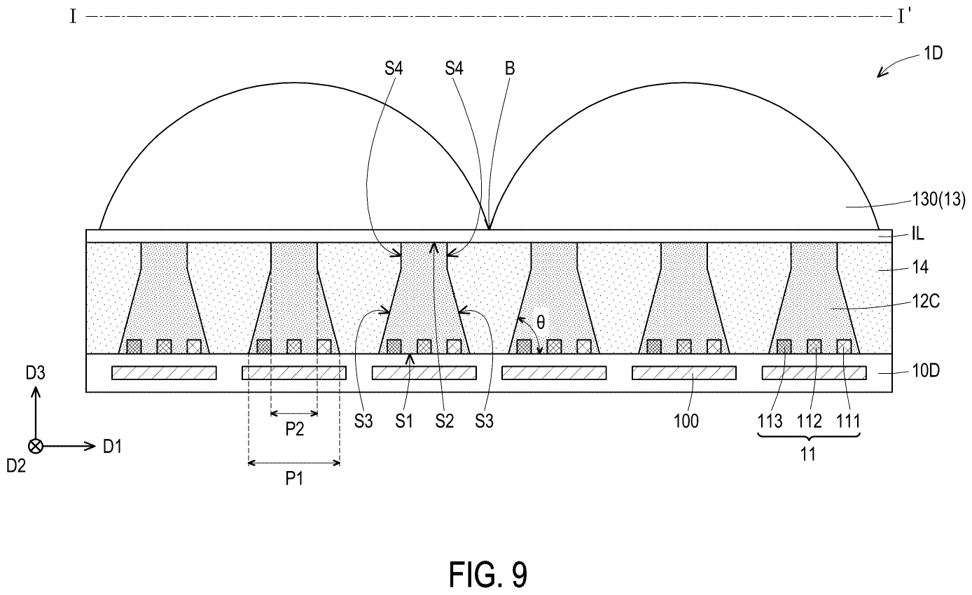

Please refer to FIG. 9. In a display device 1D, a substrate 10D is provided with a reflection layer 100 located below the display elements 11 to improve light utilization. For example, the reflection layer 100 may be formed on a base (not shown) of the substrate 10D and located between the display elements 11 and the base. The material of the reflection layer 100 may include a metallic material or a high-reflectivity material, such as molybdenum (Mo), copper (Cu), titanium (Ti), aluminum (Al), other high-reflectivity materials, or a combination thereof. In an embodiment in which the display elements 11 include multiple OLEDs, an anode of the OLED may be used as the reflection layer 100. In addition, in an embodiment in which the display elements 11 include multiple micro light-emitting diodes or multiple display units in a liquid crystal display panel, a single or multiple metal layers between the display elements 11 and the base may be used as the reflection layer 100, but not limited thereto.

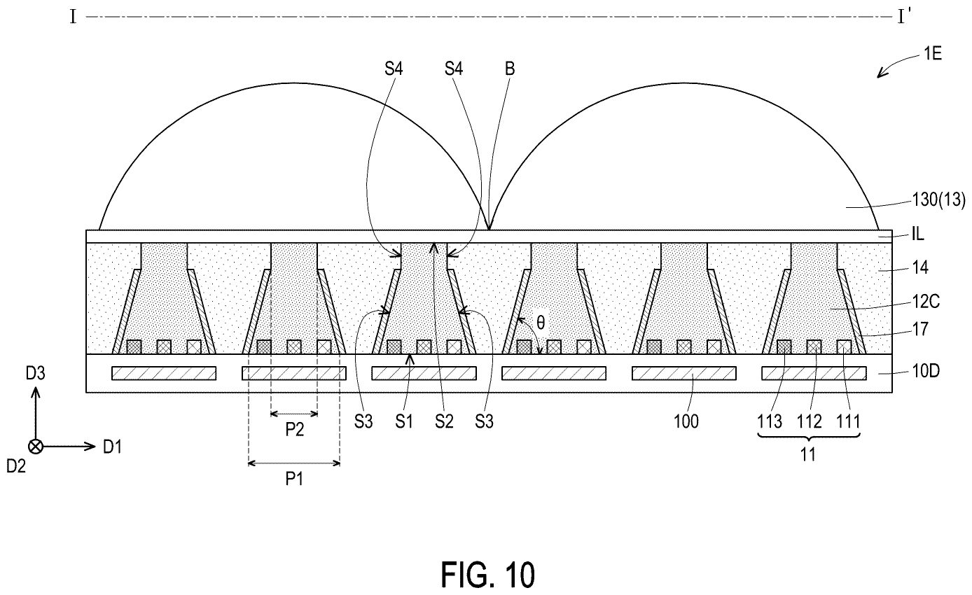

Please refer to FIG. 10. A display device 1E further includes a reflection layer 17 disposed on the side wall surface S3 to improve light utilization. The material of the reflection layer 17 may include a metallic material or a high-reflectivity material, such as molybdenum (Mo), copper (Cu), titanium (Ti), aluminum (Al), other high-reflectivity materials, or a combination thereof. According to different requirements, the reflection layer 17 may partially or completely cover the side wall surface S3. In addition, in other embodiments, although not shown, the reflection layer 17 may be further disposed on the side wall surface S4. Similarly, the reflection layer 17 may partially or completely cover the side wall surface S4.

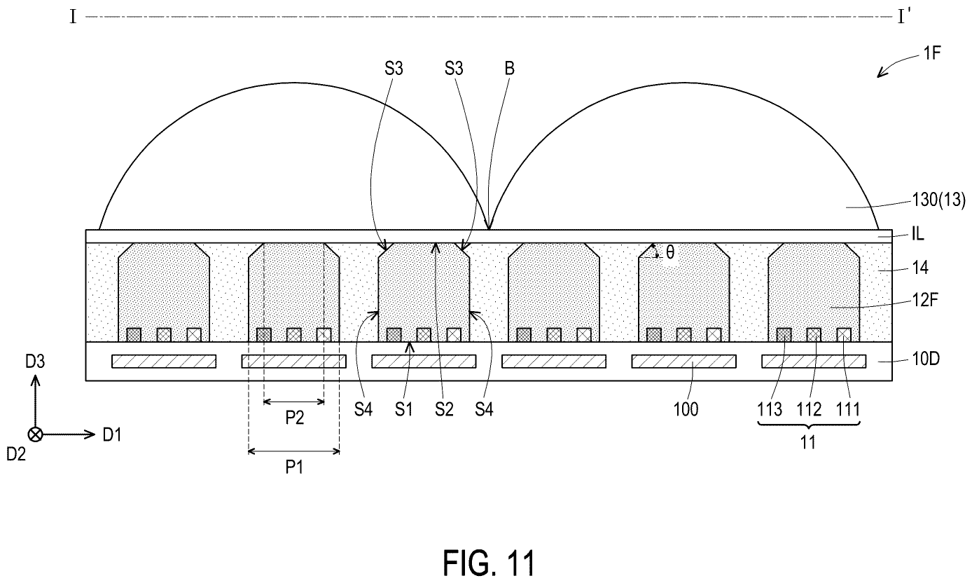

Please refer to FIG. 11, in multiple light-mixing wells 12F of a display device 1F, the side wall surface S3 is connected to the second surface S2, and the side wall surface S4 is connected to the first surface S1. In FIG. 11, the side wall surface S4 is, for example, perpendicular to the first surface S1 and the second surface S2, but an included angle between the side wall surface S3 and the first surface S1 or an included angle between the side wall surface S3 and the second surface S2 may be changed according to actual requirements, but not limited thereto.

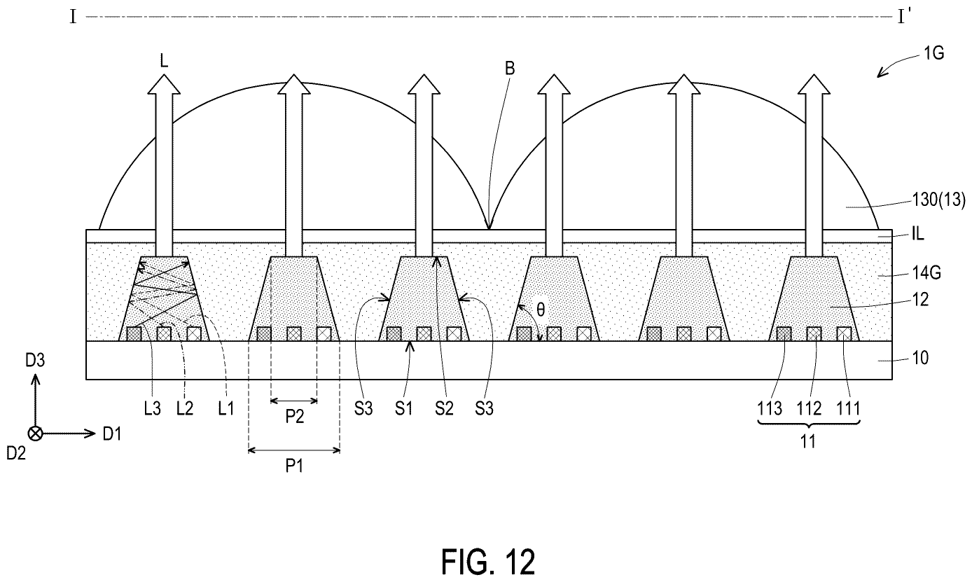

Please refer to FIG. 12. In a display device 1G, a filling layer 14G covers the second surface S2. In other words, the thickness of the filling layer 14G may be greater than the thickness of the light-mixing wells 12.

In summary, in the embodiments of the disclosure, the design of the refractive index of the filling layer being less than the refractive index of the light-mixing wells helps to improve light mixing. In addition, through the design of the orthographic projection of the first surface being greater than the orthographic projection of the second surface, the collimation of light may be improved (or the generation of stray light may be reduced) and/or light mixing may be improved. Therefore, issues such as color separation, imaging chromatic aberration, and/or poor imaging quality may be reduced, and color accuracy and/or image clarity in stereoscopic imaging may be effectively improved.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A display device, comprising:
a substrate;
a plurality of display elements, disposed on the substrate and comprising a plurality of first-color display elements and a plurality of second-color display elements;
a plurality of light-mixing wells, disposed on the display elements, wherein each of the light-mixing wells overlaps at least one corresponding first-color display element and at least one corresponding second-color display element;
a light exit structure, disposed on the light-mixing wells, wherein each of the light-mixing wells has a first surface facing the substrate and a second surface facing the light exit structure, and an orthographic projection area of the first surface on the substrate is greater than an orthographic projection area of the second surface on the substrate; and
a filling layer, disposed between the light exit structure and the substrate and located between the light-mixing wells, wherein a refractive index of the filling layer is less than a refractive index of the light-mixing wells.

2. The display device according to claim 1, wherein the display elements comprise a plurality of micro light-emitting diodes, a plurality of organic light-emitting diodes, or a plurality of display units in a liquid crystal display panel.

3. The display device according to claim 1, wherein an orthographic projection of the corresponding first-color display element on the substrate and an orthographic projection of the corresponding second-color display element on the substrate fall within an orthographic projection of an overlapping light-mixing well on the substrate.

4. The display device according to claim 1, wherein the second surface comprises at least one microstructure.

5. The display device according to claim 4, wherein the at least one microstructure comprises a triangular prism or a partial cylinder.

6. The display device according to claim 1, wherein each of the light-mixing wells further has a side wall surface located between the first surface and the second surface and inclined relative to the first surface, and an included angle between the side wall surface and the first surface is greater than or equal to 30 degrees and less than or equal to 80 degrees.

7. The display device according to claim 6, wherein the side wall surface connects the first surface and the second surface.

8. The display device according to claim 6, further comprising:
a reflection layer, disposed on the side wall surface.

9. The display device according to claim 6, wherein the side wall surface is connected to the first surface, and each of the light-mixing wells further has another side wall surface connecting the side wall surface and the second surface.

10. The display device according to claim 6, wherein the side wall surface is connected to the second surface, and each of the light-mixing wells further has another side wall surface connecting the side wall surface and the first surface.

11. The display device according to claim 6, wherein a material of the light-mixing wells comprises an organic insulating material, an inorganic insulating material, or a combination thereof.

12. The display device according to claim 1, wherein the light exit structure comprises a plurality of micro lenses, and the micro lenses and the light-mixing wells are disposed in a one-to-one or one-to-many relationship.

13. The display device according to claim 12, wherein the second surface of each of the light-mixing wells does not overlap a boundary of any two adjacent micro lenses among the micro lenses.

14. The display device according to claim 12, wherein each of the display elements does not overlap a boundary of any two adjacent micro lenses among the micro lenses.

15. The display device according to claim 1, wherein the light exit structure comprises a grating, a cylindrical lens, a meta-surface structure, or a micro lens.

16. The display device according to claim 1, wherein the filling layer exposes the second surface.

17. The display device according to claim 1, wherein the filling layer covers the second surface.

18. The display device according to claim 1, wherein the filling layer comprises an organic insulating layer, an inorganic insulating layer, or air.

19. The display device according to claim 1, wherein the substrate is provided with a reflection layer located below the display elements.

20. The display device according to claim 1, wherein the display elements further comprise a plurality of third-color display elements, and each of the light-mixing wells further overlaps at least one corresponding third-color display element.
